(19) United States
(12) Patent Application Publication
(10) Pub. No.: US 2019/0102929 A1
(43) Pub. Date: Apr. 4, 2019

(54) METHODS AND SYSTEMS FOR MEDIATING MULTIMODULE ANIMATION EVENTS

(71) Applicant: StarChat Inc., Atlanta, GA (US)

(72) Inventors: LEE DAVIS, HIGHLAND BEACH, FL (US); VIRGINIA COKER, ATLANTA, GA (US); MICHAEL MCCLUNEY, ATLANTA, GA (US); DENNIS ROLAND, BISHOP, GA (US)

(21) Appl. No.: 16/151,208

(22) Filed: Oct. 3, 2018

Related U.S. Application Data
(60) Provisional application No. 62/567,688, filed on Oct. 3, 2017.

(51) Int. Cl. G06T 13/40; G06T 17/00; G06T 15/00

(52) U.S. Cl. CPC G06T 13/40; G06T 17/00; G06T 2213/04; G06T 2213/12; G06T 15/00

(57) ABSTRACT

Systems and methods for mediating multimodule animation events may be provided. A mediating module may generate animation content in real time by combining visual data of an animation subject received from a subject interface module, animation assets received from an asset module, and animation instructions, and transmit the animation content to a viewer interface module, whereby a viewer can view the animation content.

### FIELD OF DISCLOSURE

The present disclosure relates generally to animation systems. More specifically, various embodiments of the present disclosure relate to methods and systems for interconnecting animation assets, animation processes, animation subjects, and animation viewers.

### BACKGROUND

Animation provides a source of entertainment for countless viewers. Common modes of providing animated content rely on, in many cases, pre-generating the content, by compiling input—which can include sources such as hand-drawings, digitally drawings, 3D models, and on-body motion capture—into a moving image. However, it can be desirable to have animation content that is not pre-generated but responsive to, and reflective of, input from a human subject, in real time. Moreover, it can be desirable to mediate the constituent aspects (or “modules”) of “live” animation, such as animation assets (e.g., sets of 3D models and textures), interfaces for animation subjects and animation viewers, subject capture and translation processes, and governing rulesets.

Therefore, there is a need for systems and methods, and improvements thereof, for mediating multimodule animation events.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in their trademarks and copyrights included herein, and grants permission to reproduce the material only in connection with reproduction of the granted patent and for no other purpose.

Furthermore, the drawings and their brief descriptions below may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment, in accordance with various embodiments of the present disclosure.

FIG. 2 illustrates a operation of a system mediating multimodule animation events, in accordance with various embodiments of the present disclosure.

FIG. 3 illustrates a flowchart of a method of delivering animation content, in accordance with various embodiments of the present disclosure.

FIG. 4 illustrates a block diagram of a system for mediating multimodule animation events, in accordance with various embodiments.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One objective of the disclosed platform may be to facilitate the animation of a person (or “animation subject”) in real time (or “live”), by capturing video of that person, and translating that person's motions, mannerisms, and other characteristics into an animated character.

Additionally, another objective of the platform may be to transmit to viewers live animation content featuring an animated character, for example in an in-person, “live streaming” or “live broadcast” context.

Similarly, another objective of the platform may be to transmit to viewers pre-recorded messages comprising live animation content.

Further, another objective of the platform may be to facilitate the live animation of an animated character based on animation assets (such as 3D models and textures) for that character and animation instructions or algorithms.

Another objective of the platform may be to provide for the separation and securing of animation assets from other parts of the platform.

Still another objective of the platform may be to determine whether viewers have paid for, or otherwise made themselves eligible for, the viewing of animation content.

Further, another objective of the platform may be to determine whether viewers have permission to view particular content, based on content rules (e.g. a permission setting forbidding a viewer from viewing streams tagged as containing mature content).

Further still, another objective of the platform may be to determine whether animation content, as it is being generated, is in compliance with content rules (e.g. regarding mature content).

Another objective of the platform may be to allow a partner, licensor, or other interested party to monitor or administer animation assets and animation content that is generated from those assets.

Embodiments of the present disclosure provide a platform comprising, but not limited to:
Interface modules. Viewer and subject interface modules may include input and output devices (e.g., video capture devices and display devices), and provide to the platform visual data related to animation subjects;
Asset modules. Asset modules may contain animation assets (models, graphics, wireframes, animation sequences, etc.) to be animated into animated characters;
Animation modules. Animation modules may contain instructions and data used to animate animation assets into animated characters, based on visual data related to animation subjects;
Rules modules. Rules modules may contain rules that govern how, whether, and under what circumstances various system actions may be undertaken, such as accessibility of content to users and allowable inputs and/or outputs to the animation process;
Payment modules. Payment modules may contain records what content users have paid for, or are otherwise entitled to view;
Other modules. Other modules may communicate or otherwise interface with the platform and its modules; and
Mediating modules. Mediating modules coordinate the stages performed by other modules and communications between them.

Embodiments of the present disclosure are described with reference to a mediating module that connects together component modules of a live-animating platform. It should be understood that such mediating module is disclosed as only one example to enable the certain embodiments disclosed herein.

In one example, viewers may indicate in a user interface (such as an app) particular live animation content they wish to view. Broadly understood, “live animation content” may encompass animation content that is generated in real time (or nearly so) from an animation subject, without regard for when that content is viewed. Live animation content may be “live streamed” in an interactivity session between a viewer and an animation subject, so as to be viewable by viewers substantially in temporal accord with the actions of the animation subject being animated. Live animation content may also be generated and stored so as to be viewable at a later time. Although reference with regard to live animation content is made throughout the present disclosure, it should be understood that the embodiments disclosed herein may be compatible with both live and post-processing implementations.

The provision by this platform of live animation content might, for example, arise in the context of a viewer selecting the live stream or a custom recording of a particular live animation subject (e.g., Tom Celebrity's animated character Tom Panda Bear), or selecting content to which they are subscribed, or entering into a “channel” of live animation content, etc.

The viewer's indication may be transmitted to a server which, in various embodiments, may be configured to function, at least in part, as the aforementioned mediating module, facilitating the provision of live animation content back to the viewer in a multimodule platform. The mediating module may employ the platform modules to determine, based on the request, what content to provide and whether the viewer is entitled to view that content. For example, a viewer might be disallowed from viewing content based on at least one rule specified for the viewer in a rules module such as mature content filtering or geographic restrictions (e.g. due to licensing limitations), or based on payment information from a payment module such as whether the viewer had paid a subscription or one-time fee.

In some embodiments, a determination may further be made if the animation assets corresponding to the viewer's request can be used in the procurement of the user's request. Once the necessary checks are performed as to, for example, the procurement of an animation asset with the viewer's request, and a determination that the viewer is entitled to view the animation content, content corresponding to the viewer's request may either be generated and provided to the viewer or, in other instances, previously generated content provided to the user. That is, the platform may undertake different operations depending on, among other factors, whether fulfilling the viewer's request requires the generation of new animation content or whether the fulfilling the viewer's request may employ existing or in-progress animation content generated.

Consistent with embodiments of the present disclosure, an interface module operating software and hardware components may be employed to capture data, such as, for example, but not limited to, audio or video data, related to the animation subject. In an example, the module may be or be operable on a mobile device, such as a smartphone that has camera, microphone, display, and networking components. An animation subject may employ the interface module in the furtherance of fulfilling the viewer's request. For example, the viewer's request may be a request for Tom Panda Bear to sing and dance a Happy Birthday song for the viewer. The animation subject may perform the song and dance, which may, in turn, be captured by the interface module.

Still consistent with embodiments of the present disclosure, captured data may be transmitted to the mediating module, which requests animation assets—the various models, graphics, structural data, and anything else used to render an animation character (e.g., assets associated with Tom Panda Bear)—from an asset module. The captured data and animation assets may then transmitted to an animating module which combines them (along with, potentially, audio and other data) into animation content. Animation instructions for animating the content may be based, at least in part, on any or more of the following: the request, the captured data, and the assets, and may be employed in the generation of the animation. The generated animation content may then be transmitted to the viewer, who ultimately sees, in this example, the result of the “actor” subject's movement and voice portrayed as an animated character, on the viewer's display.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of stages of various processes or methods that are described herein are illustrative and not restrictive. Accordingly, it should be understood that, although stages of various processes or methods may be shown and described as being in a sequence or temporal order, the stages of any such processes or methods are not limited to being carried out in any particular sequence or order, absent an indication otherwise. Indeed, the stages in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “stage for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

I. Platform Overview

Consistent with embodiments of the present disclosure, a platform for mediating multimodule animation events (or simply “platform”) 100 may be provided. This overview is provided to introduce a selection of concepts in a simplified form that are further described below. This overview is not intended to identify key features or essential features of the claimed subject matter. Nor is this overview intended to be used to limit the claimed subject matter's scope.

Platform 100 may be used by individuals or companies to, by way of non-limiting example, produce, deliver, and display animation content. Accordingly, platform 100 may be configured to, by way of non-limiting example, capture visual and other data from an animation subject 135, and mediate the combination of such data with animation assets 141 and animating instructions to generate animation content and transmit that content to a viewer. For the purposes of this disclosure, anywhere reference is made to “visual” or “video” data, depictions, capture, etc., other data such as audio and sensor data may be captured, included, transmitted, received, etc.

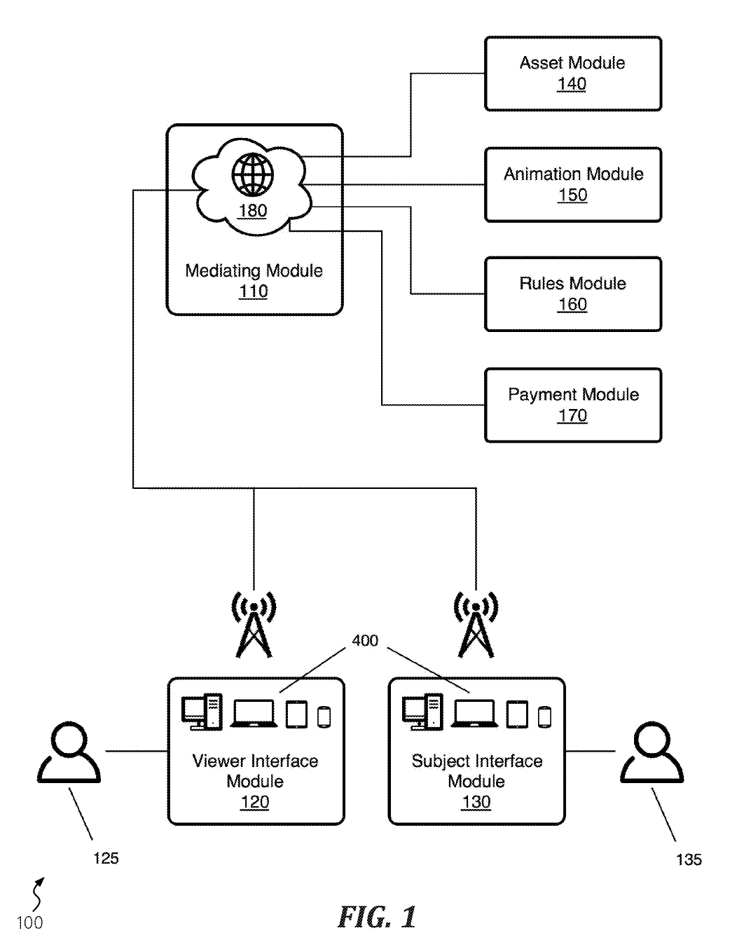

The following disclosure is made with reference to FIGS. 1-4.

### A. MODULES

Embodiments of the present disclosure provide a software and hardware platform comprising a distributed set of modules, including, but not limited to:
1. Mediating Module 110
2. Viewer Interface Module 120
3. Subject Interface Module 130
4. Asset Module 140
5. Animation Module 150
6. Rules Module 160
7. Payment Module 170

FIG. 1 illustrates a non-limiting example of an operating environment for the aforementioned modules. Although modules are disclosed with specific functionality, it should be understood that functionality may be shared between modules, with some functions split between modules, while other functions duplicated by the modules. Furthermore, the name of the module should not be construed as limiting upon the functionality of the module.

Moreover, each stage associated with a module can be considered independently without the context of the other stages disclosed in the same or other modules. Furthermore each stage may contain language defined in other portions of this specifications. Each stage disclosed for one module may be mixed with the operational stages of another module. Accordingly, each stage can be claimed on its own and/or interchangeably with other stages of other modules.

A first embodiment disclosing, for example, a transmission or reception of data from on module to another may be, for example, in a second embodiment, eliminated or combined where a function disclosed to be performed by more than one module is configured, in the second embodiments, to be performed by the same module. The following descriptions will detail non-limiting examples of operation of each module, and inter-operation between modules.

### B. PLATFORM MODULE DETAILS

In various embodiments disclosed herein, mediation module 110 may facilitate communication between other modules and facilitate an end-to-end operation of platform 100. For example, mediating module 110 may be enabled to, but not limited to, provide at least one of the following:
a. operatively connect animation subject 135 visual (and other) data with the assets 141 (module 140) and animating instructions (module 130 OR 150) that are used to animate the subject 135,
b. operatively connect modules involved in animation with rules (module 160) that govern how and whether animation content will be generated and/or presented, given subject 135 input, which may include governing how and whether accompanying data such as audio or textual data will be generated and/or presented, and
c. interconnect other modules while keeping their functions and data access siloed, with overall platform 100 direction and governance constrained to a central mediating module 110.

In various embodiments disclosed herein, mediation module 110 may interact with viewer interface module 120 to facilitate an end-to-end operation of platform 100. For example, mediating module 110 may interact with interface module 120 to perform at least one of the following:
a. receive request input from viewer 125,
b. mediate (i.e. determines the accessibility of data/content to, and allow or forbid the transmission of animation content to) viewer 125 access via, e.g., rules in a rules module 160, or payment data 171 in a payment module 170, and
c. transmit animation data, received from animation module 150, to viewer 125.

In various embodiments disclosed herein, mediation module 110 may interact with subject interface module 130 to facilitate an end-to-end operation of platform 100. For example, mediating module 110 may interact with subject interface module 130 to perform at least one of the following:
a. receive sensor data (e.g., camera) from sensors associated with a hardware component of subject interface module 130,
b. generate instructions for animating assets based on the sensor data, wherein the instructions may be generated at either module 130 AND/OR module 150, wherein the instructions follow a platform protocol understood by each module,
c. transmit captured data to animation module 150,
d. receive animation content resulting from operation of other modules and display to subject 135 (e.g. as a feedback mechanism), and
e. provide to subject 135 metrics from various modules, including monetization data from the payment module 170.

In various embodiments disclosed herein, mediation module 110 may interact with asset module 140 to facilitate an end-to-end operation of platform 100. For example, mediating module 110 may interact with asset module 140 to perform at least one of the following:
a. transmit requests for animation assets 141 to asset module 140, and
b. receive animation assets 141 from asset module 140.

In various embodiments disclosed herein, mediation module 110 may interact with animation module 150 to facilitate an end-to-end operation of platform 100. For example, mediating module 110 may interact with animation module 150 to perform at least one of the following:
a. transmit animation assets 141 to animation module 150,
b. transmit captured data of subject 135 to animation module 150, and
c. receive animation content from animation module 150.

In various embodiments disclosed herein, mediation module 110 may interact with rules module 160 to facilitate an end-to-end operation of platform 100. For example, mediating module 110 may interact with rules module 160 to perform at least one of the following:
a. transmit rules from a variety of sources to the rules module 160, including, for example, but not limited to:
   A viewer 125,
   A subject 135,
   An asset administrator 145, and
   A platform admin 105,
b. receive rules stored in rules module 160, and
c. apply rules received from rules module 160.

In various embodiments disclosed herein, mediation module 110 may interact with payment module 170 to facilitate an end-to-end operation of platform 100. For example, mediating module 110 may interact with payment module 170 to perform at least one of the following:
a. transmits payment data 171 from viewer interface module 120 to payment module 170, and
b. receives payment data 171.

In various embodiments disclosed herein, the following functions and operations may be performed to facilitate an end-to-end operation of platform 100. For illustrative purposes, the functions and operations are listed in association with a module that may be configured to perform the corresponding functions and operations.
1. The Viewer Interface Module 120 may be configured to:
   a. receive viewer 125 input to platform 100, and
   b. allow viewer 125 to select and view animation content.
2. The Subject Interface Module 130 may be configured to:
   a. allow subject 135 to interact with platform 100, wherein (a) comprises:
      i. accessing and respond to content requests from a viewer 125 or group thereof, and
      ii. providing access to monetization data,
   b. capture video (and/or other sensor) data of subject 135, and
   c. transmit captured data to mediating module 110 for animation by the animation module 150.
3. The Asset Module 140 may be configured to:
   a. Source of animation assets 141,
   b. Transmission of animation assets 141 may be governed by an asset administrator 145 (e.g. a person, entity, or agent, including possibly that of a partner or licensee, effecting quality control measures; asset administration may involve a general platform user interface, a dedicated user interface, an administrator interface module, etc.), and
   c. Multiple asset modules 140 may exist.

In some embodiments each animation character may have its own asset module 140 that is accessed only when an animation request is made (by e.g. a viewer 125 or subject 135) to animate that character. In some embodiments, asset module 140 may contain character model/graphic data that is basic, incomplete (in the sense of sufficiency to generate animation content), in a pre-processing state, or otherwise require the functioning of another module (e.g. an animation module 150) in order to generate animation content.
4. The Animation Module 150 may be configured to:
   a. receive animation assets 141,
   b. receive captured data of subjects 135,
   c. process animation instructions to generate animation content, based on, for example, but not limited to, at least one of visual, video, audio, etc., using, for example, image processing techniques, including, for example, but not limited to, facial recognition, and
   d. transmit animation content to the mediating module 110.

As with other modules, all or part of the functionality of asset module 140 and animation module 150 may be combined, commingled, swapped, or subjected to enable the platform within the spirit and scope of the present disclosure. Furthermore, and still consistent with embodiments of the present disclosure, platform 100 may comprise multiple animation modules 150 and multiple asset modules 140. Where multiple asset 140 and animation 150 modules exist, each might be a “pair” or combined into one module for the animation of a particular asset 141.
5. The Rules Module 160 may be configured to:
   a. receives, store, and transmit rules from various modules.

In various embodiments, multiple rules modules 160 may be configured, and various rules modules may interface directly with other modules. By way of non-limiting example:
a. a viewer interface module 120 or subject interface module 130 may comprise or be connected to a rules module 160 that houses rules (or rules “preferences”),
b. an asset module 140 may comprise or be connected to a rules module 160 that houses rules governing how and whether an asset 141 is to be animated, and
c. platform 100 or mediating module 110 may have global or multi-module rules contained in a rules module 160.

In other embodiments, such rules may be stored in a central rules module mediated by module 110 rather than in an individual rules module 160 connected to that module.
6. The Payment Module 170 may be configured to:
   a. receive, store, and transmit data regarding viewer 125 payments.

As with rules module 160, multiple payment modules 170 may be configured. By way of non-limiting example, in some embodiments, each viewer interface module 120 or subject interface module 130 may be associated with a payment module 170.

### C. COMPUTING ELEMENTS

The aforementioned modules and functions and operations associated therewith may be operated by a computing device. In some embodiments, each module may be performed by separate, networked computing devices; while in other embodiments, certain modules may be performed by the same computing device. Accordingly, embodiments of the present disclosure provide a software and hardware platform comprising a distributed set of computing elements, including, but not limited to:
1. A Computing Device 400
Computing device 400 may comprise, but not limited to at least one of the following:
   A processing unit 402, and
   A memory storage,
Wherein computing device 400 may be embodied as, for example, but not limited to:
   A server,
   A desktop computer,
   A laptop,
   A distributed computing system,
   A smartphone,
   A tablet,
   A personal electronic device,
   A drone,
   A vehicle,
   A camera, and
   A remotely operable recording device;
Wherein a computing device 400 may comprise a sensing device that may for example be, but is not limited to:
   A camera, and
   A microphone; and
Wherein the computing device 400 may be in communication with a sensing device,
Wherein the sensing device may provide one or more of:
   visual data,
   spatial data,
   motion data,
   environmental data, and
   acoustic data,
Wherein the computing device 400 may be embodied as any of the computing elements illustrated in FIG. 1, including but not limited to, mediating module 110, viewer interface module 120, subject interface module 130, asset module 140, animation module 150, rules module 160, and payment module 170.
2. Sub-Modules Associated with a Computing Device 400 Platform 100 may be operative to control at least one of the following Sub-Modules of a Computing Device 400:
   A user interface module,
   A content capturing module, and
   A communications module.
   a. User Interface Module
      i. May enable user control of a Computing Device
      ii. May enable user control of modules and sub-modules of a computing device which may include
         A user interface module
         A content capturing module
         A communications module
      iii. May enable user control of various platform 100 modules which may include
         A mediating module 110
         A viewer interface module 120
         A subject interface module 130
         An asset module 140
         An animation module 150
         A rules module 160
         A payment module 170
      iv. May enable user control of various other module and sub-modules which may include
         A content generation module
         A content transmission module
         A content organization module
         A content display module
   b. Content Capturing Module
      i. May enable operative control of content recordation hardware, which may include
         sensing devices
         Optical Sensors
         Audio Sensors
         Telemetry Sensors
      ii. May enable capturing based on data
         Recordation of content received from a sensing device
         Recordation of content received from a communications module
      iii. May enable Digital Signal Processing on captured content
         May enable the generation, by a module such as an animation module 150, animation content based on, but not limited to, visual data captured of an animation subject 135
         May enable image or video processing techniques
   c. Communications Module
      i. May enable the networking of modules
      ii. May be associated with multiple networked devices
      iii. May be in operative communication with other communications modules of computing devices capturing, mediating, transmitting, or generating data
      iv. May be configured to communicate with nearby devices also running on platform 100
      v. May remotely control content capture
         Remote control of a camera
         Remote control of a microphone
         Remote control of other sensing devices

Various hardware components may be used at the various stages of operations follow the method and computer-readable medium. For example, although the methods have been described to be performed by a computing device 400, it should be understood that, in some embodiments, different operations may be performed by different networked elements in operative communication with the computing device. For example, computing device 400 may be employed in the performance of some or all of the stages disclosed with regard to the methods below.

### D. METHODS

Embodiments of the present disclosure provide a hardware and software platform operative by a set of methods and computer-readable media comprising instructions configured to operate the aforementioned modules and computing elements in accordance with the methods.

The methods and computer-readable media may comprise a set of instructions which when executed are configured to enable a method for inter-operating at least one of the following modules:
A mediating module 110,
A viewer interface module 120,
A subject interface module 130,
An asset module 140,
An animation module 150,
A rules module 160, and
A payment module 170.

The aforementioned modules may be inter-operated to perform a method comprising, for example, but not limited to, the following stages:
1. Receiving a request for animation content, wherein the request is transmitted by a viewer interface module 120, further wherein viewer interface 120 module enables a viewer 125 to specify at least one of the following:
   a. a selection between available animation content,
   b. a name of an animation subject 135,
   c. a custom message or “script” to be animated;
   d. a custom image to serve as the background for the animation content, wherein viewer 125 may provide a picture of for example, their living room, a local football field, a beach scene, and have the picture serve as the background for the video,
   e. a name of an animation content channel,
   f. a name of an animation content genre or content grouping,
   g. a proposed budget,
   h. a selection among a collection of content grouped by price (may comprise “free”),
   i. a selection indicating desire for random content, further wherein the request may be received or transmitted by way of an interface mechanism comprising at least one of:
      a website,
      a web service,
      a cloud platform,
      an application,
      a mobile device app,
      and an operating system,
   upon viewer 125 utilizing or accessing such interface mechanism, further wherein the request is received by mediating module 110;
2. Determining whether the request for the animation content is to be provisioned, wherein determining comprises:
   accessing at least one of a rules module 160 and a payment module 170 in order to verify the user's permission to view the animation content,
   wherein accessing a rules module 160 comprises accessing at least one rule related to the viewer contained in the rules module 160,
   wherein accessing a rules module 160 comprises accessing at least one rule related to the message or “script” to be animated to determine if the message or “script” is acceptable based on rules governing the usage of a required animation asset, and
   wherein accessing a payment module 170 comprises accessing at least one record related to the viewer contained in the payment module 170;
3. Proceeding, if it is determined in stage 2 above that animation content is to be provisioned, to stage 4 below, and otherwise ceasing the process;
4. Determining, from the request for animation content, whether the requested content calls for one of:
   a. live-feed live animation content,
   b. recorded live animation content, or
   c. custom live animation content;
5. Proceeding,
   a. if the request calls for live-feed live animation content, to stage 15 below, as provisioned contemporaneously with animation content following substantially stages 8 through 14 below,
   b. if the request calls for recorded live animation content, to stage 15 below, as provisioned previously with animation content following substantially stages 8 through 14 below, or
   c. if the request calls for custom live animation content, to stage 6 below;
6. Transmitting the request for animation content to a subject interface module 130;
7. Providing an indication to an animation subject 135 that animation content has been requested, wherein the indication is provided by the subject interface module 130;
8. Capturing data depicting an animation subject 135, wherein the capturing data is performed by a subject interface module 130, further wherein the subject interface module 130 comprises one or more submodules comprising at least one of:
   a. a camera,
   b. a microphone,
   c. an optical sensor, and
   d. a non-optical sensor;
9. Receiving data, wherein the data is transmitted by the subject interface module 130;
10. Transmitting, to an asset module 140, a request for animation assets 141 corresponding to the requested animation content;
11. Receiving, from an asset module 140, animation assets 141 corresponding to the requested animation content;
12. Transmitting, to an animation module 150, visual data and the animation assets 141;
13. Generating animation content using the visual data and animation assets 141, wherein the generating is performed by the animation module 150;
14. Storing the animation content in a non-transient computer readable medium;
15. Transmitting the animation content to the viewer interface module 120;
16. Displaying, for the viewer 125, the animation content, wherein the displaying is performed by the viewer interface module 120.

### E. EXAMPLES

### 1. Example 1

Platform 100 may be configured to facilitate a content stream comprising animation content viewable by a viewer 125, wherein the animated content is generated in real time by capturing, at the subject module interface 130, visual depictions (e.g. video, possibly including data such as audio or sensor data) of an animation subject 135. For example, animation subject 135 might be in front of a webcam. Video capture data can be transmitted to mediating module 110, which can receive animation assets from an asset module 140 and combine the video capture data with animating instructions received from an animation module 150. Platform 100 may then transmit the animation content from mediating module 110 to viewer interface module 120.

In some embodiments, animation subject 135 may not be required, or be embodied as a software simulation. As such, animation instructions based on the context of a message to be delivered. For example, a simulator may use natural language processing techniques to read the context of a desired message to be communicated, and generate corresponding animations (e.g., body and facial expressions) associated with the message. Furthermore, in some embodiments, platform 100 may be configured such that an audio generation module may comprise tones associated with certain animation assets, such that the voice of an animation asset may be reconstructed to provide the audio message.

### 2. Example 2

Platform 100 may be configured to facilitate the live broadcast of an animation subject 135, as animated, in the visual form of an animation character. For example, a company can have an animation character identified with its brand, and hold live, bi-directional video chat sessions or public broadcasts, in real time, featuring the animation character as animated by an animation subject 135. The brand-identifying character's animation assets (e.g. wireframes and textures) can be stored in an asset module 140, while rules regarding allowable content (e.g. forbidding certain verbal and gestural content from being animated) can be stored in a rules module 160. Mediating module 110 can apply the animation assets from the asset module 140 to the animation subject 135 via the animation module 150, subject to filters or restrictions in the rules module 160.

### 3. Example 3

Platform 100 can facilitate the animation of an animation subject 135 who is a celebrity, public figure, or expert (or other person) who wishes to monetize their time via live or recorded animated video sessions provided by, for example, a commissioned subject 135. A viewer 125 may desire to watch such animation content (e.g. as a stream), or to participate in an interactive animated session (e.g. in a live, scheduled, public, or private interactive chat), and mediating module 110 may poll a payment module to see if the viewer 125 has paid a requisite subscription fee or one-time charge. Mediating module 110 may grant or deny access to the stream based on payment module 170 data, or non-payment may direct/allow viewer 125 to pay (via, e.g., a credit card entry form, an in in-app purchase button, a secure authentication method that enables access to stored payment information, etc.).

### 4. Example 4

Platform 100 may allow or restrict a viewer's 125 access to certain types of content, e.g. content intended for a mature audience, based on information stored in a rules module 160. For example, a child viewer 125 may have parental controls set by a parent that prevent viewer 125 from viewing animation content with static identifiers—an animation subject 135 might set a flag on their account notifying potential viewers that their “channel” features explicit language—or based identification of objectionable content by mediating module 110.

### 5. Example 5

Rules about the functionality or allowable modalities of an animation character may be stored in a rules module 160 connected to or related with an asset module 140 or animation module 150 (or constituent records or data therein). A viewer 125 may be prevented by a rules module 160 (or similar mechanism) from requesting content generation based on particular inputs. For example, if a buyer wished to purchase a customized birthday greeting for a viewer 125 from an animation character, a rules module 160 (or another module, based on rules module 160 input) might prevent the process from proceeding if the submitted “script” contained words that triggered one or more rules in a rules module 160. In a similar vein, a subject 135 may move, gesture, or vocalize in a way that a rules module 160 disallows from being animated (preventing that animated character from being animated acting or speaking thusly).

### 6. Example 6

Rules about an animation subject's preferences and capabilities may be stored in a rules module 160 connected to or related with a subject interface module 130. A viewer 125 may be prevented by a rules module 160 (or similar mechanism) from requesting content generation based on particular inputs. For example, if a viewer 125 wished to purchase a customized “shoutout” from an animation character, a rules module 160 might prevent the process from proceeding if the submitted “script” was in a language not flagged as spoken by the animation subject 135—or, in a case where there are multiple animatable “actors” for a character, any of the animation subjects 135—upon whom the character's animation would be based. Whereas, a language rule may allow platform 100 to select an appropriate subject 135 where at least one such “actor” spoke that language.

### 7. Example 7

Platform 100 may provide a mechanism by which viewers 125 can rate, review, increment a “like” counter, or otherwise indicate their preferences and satisfaction with animation content. This mechanism may be applied per animated character, per animation subject 135, per channel, etc. In an example, data regarding user preferences can be utilized by platform 100 to steer more animation requests to particularly well-performing subjects 135 out of a pool of subjects who all serve as “actors” for a single character (e.g. a pool of ten subjects 135 who can each to serve as the visual and voice basis of popular animated character Frank Actionhero). This may further include user interaction data gathered by platform 100 (i.e. not expressed directly by viewers 125, but gleaned by analytics), as well as artificial intelligence and machine learning processes.

### 8. Example 8

Platform 100 can transmit animated video back to an animation subject 135. For example, a subject 135 may be interacting with a subject interface module 130, provide a command to imitate a capturing session, and see in real time, on the mobile device screen, the animation content being generated from visual data (captured by the mobile device camera) depicting the subject 135. Similarly, a subject 135 who is captured to animate an animated character (e.g. a superhero or a company's brand character) may be “backstage” at an event, generating voice and visual data and viewing the animated character as feedback, while the animation content is displayed to the event audience.

### 9. Example 9

Platform 100 may be configurable to display a custom or themed user interface—for example to viewers 125 at viewer interface module 120 or subjects 135 at subject interface module 130—based on various factors. In an example, the user interface in which a particular animation stream or channel for a cartoon character is presented might reflect graphical style and branding related to that character. In another example, a partner or licensee might utilize platform 100 (or an instance of such) as a vehicle dedicated solely to the presentation of live animation content for their character(s), universe(s) of characters, or multiple IP's. In some examples, platform 100 could be utilized in multiple, company- or brand-specific apps that are respectively dedicated to specific licensees' characters. These examples might involve various aspects dedicated to the licensee and their app, such as a “re-skin” of the interface modules 120, 130, dedicated asset 140, rules 160, payment 170, and other modules, dedicated asset administrator 145 capabilities, a managed pool of subjects 135, subject management capabilities, etc.

II. Platform Configuration

FIG. 1 depicts a block diagram for one possible embodiment of a system for mediating multimodule animation events. A mediating module 110 may be provided in order to facilitate the animation of an animation subject 135 and subsequent transmission of the generated animation content to a viewer 125. Mediating module 110 may comprise or otherwise be associated with, various modules, including, but not limited to, a viewer interface module 120, a subject interface module 130, an asset module 140, an animation module 150, a rules module 160, and a payment module 170. Details with regards to these modules are provided above. Some or all modules can be integrated into a single computing system, as with a server housing multiple databases. Modules can also be part of a different computing system from the mediating module 110, as with an asset module 140 controlled and secured by a customer with one or more proprietary or protected animation characters.

Consistent with embodiments of the present disclosure, the aforementioned modules may be interconnected in various ways and communication between the modules may occur in various media. By way of non-limiting example, connections between modules can be over a network 180 such as the internet or an intranet, a cloud service or platform, within or involving a singular or distributed computing system (e.g. a server, a personal computer, a mobile device, etc.), and other means generally known in the art for connecting computing modules. For example, in a cloud computing environment, mediation module 110 may be embodied as, at least in part, a centralized server in operative communication and control of various modules, in operative communication with other computing devices (e.g., computing devices associated with, for example, viewer interface module 120 and subject interface module 130). In yet further embodiments, each animation asset and rules module may reside with a networked environment in operative control of an owner of those assets. In such embodiments, platform 100 may be configured to employ mediation module 110 to communicate with external modules in accordance to established communication protocols for enabling platform 100's end to end operation.

Still consistent with various embodiments disclosed herein, platform 100 may operate by coordinating, through the mediating module 110, the creation of animation content that may be based on visual data depicting an animation subject 135, audio data captured from a subject's 135 environment, as well as other sensor data. This data can, for example, be captured by a mobile device camera, a webcam attached to a personal computer, a discrete video camera device, etc.

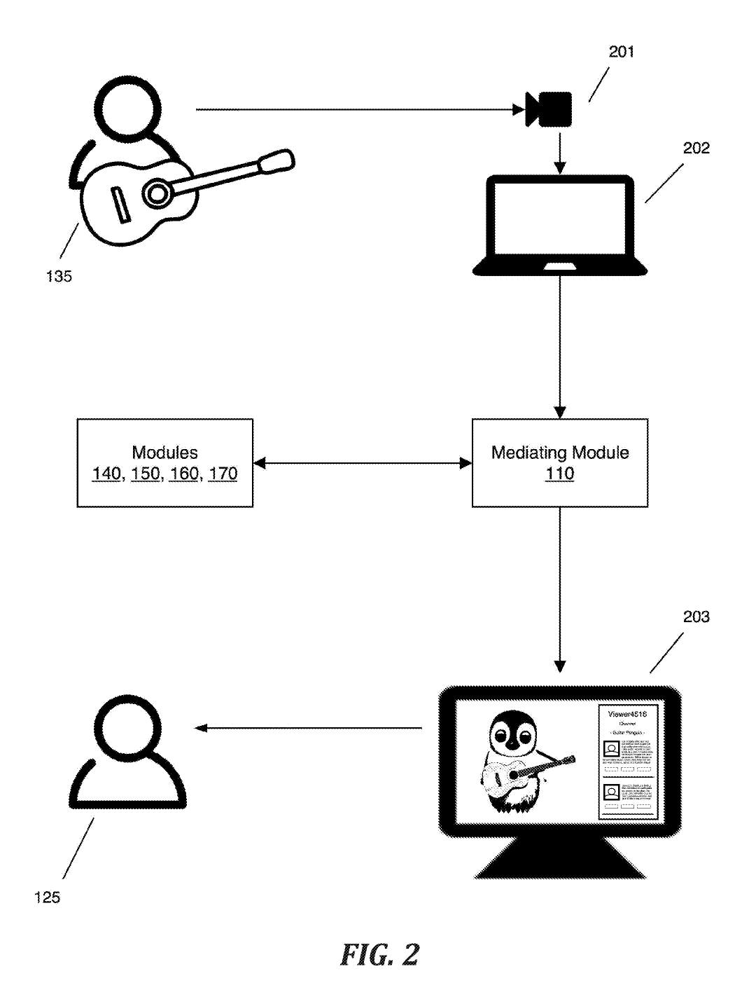

FIG. 2 depicts one embodiment of a system for mediating multimodule animation events. A subject interface module 130 may comprising, e.g., camera 201 attached to laptop 202. Platform 100 can capture, via subject interface module 130, visual data depicting an animation subject 135. Platform 100 may also capture other data such as audio data and, in this example, the subject 135, may be singing and playing a guitar. It should be noted that subject 135 may be a viewer 125, and in some embodiments may be the only viewer. For example, in the context of an app that allows subjects 135 to live animate themselves, or a public “booth” allowing a subject 135 to walk up and view (as a viewer 125) themselves being animated. It follows that viewer interface module 120 may be one and the same with subject interface module 130, or otherwise operative from the same device.

The visual (including, in keeping with usage throughout this disclosure, audio and other) data may be transmitted to the mediating module 110, which interfaces with modules in the animation process such as the asset 140, animation 150, rules 160, payment 170, and other modules (e.g. an AI module, an audio processing/FX module). In this way, the multimodule system comprising by the platform 100 may generate animation content.

Referring still to FIG. 2, the animated character is a cartoon penguin, whose facial and body movements mirror the subject 135, who wields a cartoon guitar as the subject 135 does, and whose voice and audio are generated by the subject 135 (directly or processed by platform 100). As illustrated in FIG. 2, mediating module 110 may be configured to transmit the animation content to the viewer interface module 120 (for example, desktop computer 203), which can display the animation content for the user 125.

III. Platform Operation

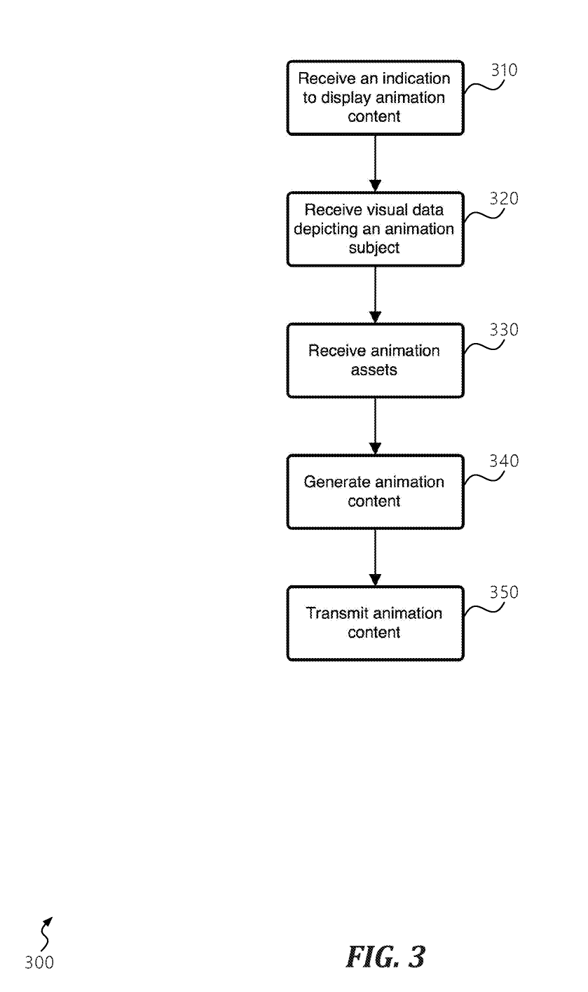

FIG. 3 depicts a method 300 for one embodiment of mediating multimodule animation events. Although method 300 has been described to be performed by platform 100, it should be understood that computing device 400 may be used to perform the various stages of method 300. Furthermore, in some embodiments, different operations may be performed by different networked elements in operative communication with computing device 400. For example, a server may be employed in the performance of some or all of the stages in method 300. Moreover, a server may be configured much like computing device 400. Similarly, a computing apparatus may be employed in the performance of some or all of the stages in method 300. A computing apparatus may also be configured much like computing device 400.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 300 will be described in greater detail below.

Method 300 may begin at stage 310 where platform 100 may receive an indication to display animation content. In some embodiments, the indication may be received from a viewer 125 at mediating module 110. This indication can be transmitted to the mediating module 110 via the viewer interface module 120. This stage may be the genesis of an animation content generation event, or simply a request to view content that is pre-existing or is already being generated irrespective of an individual user's indication (e.g. a live stream to a subscriber audience of arbitrary size).

At stage 320, platform 100 can receive visual (and possibly other) data depicting subject 135. In some embodiments, the data may be captured at and transmitted by subject interface module 130 and received by mediating module 110. The device(s) comprising subject interface module 130 can include various computing, sensing, and input devices such as mobile devices, personal computers, smart TVs, professional video capture devices, sensors (thermal, gyroscopic, IR, temperature, humidity, depth, and a wide variety of others), microphones, holographic lenses, keyboards, VR devices, etc.

At stage 330, platform 100 can receive animation assets 141. In some embodiments, animation assets 141 may be transmitted by asset module 140 and received at mediating module 110. These assets 141 can comprise many types of graphical and spatial information, such as wireframes, textures, vector assets, raster assets, 3D-models, point clouds, layers, shapes, perspectives, transition and movement information, animation sequences, collections, groupings, and sequences of various assets, etc. Collectively, the animation assets 141 may form the universe of possible depictions of an animation character, to correspond with the visual data depicting an animation subject 135.

At stage 340, platform 100 can generate animation content based on visual data, animation assets 141, and animation instructions. In some embodiments, generating animation content may be performed by animating module 150.

At stage 350, platform 100 can display the animation content to user 125. In some embodiments, mediating module 110 may transmit the animation content to viewer interface module 120 (e.g. a mobile device, television, or amphitheater display).

IV. Computing Device

The platform 100 may be embodied as, for example, but not be limited to, a website, a web application, a desktop application, and a mobile application compatible with a computing device. Moreover, platform 100 may be hosted on a centralized server, such as, for example, a cloud computing service. Alternatively, platform 100 may be implemented in one or more of the plurality of mobile devices. Although methods disclosed herein have been described to be performed by a computing device 400, it should be understood that, in some embodiments, different operations may be performed by different networked elements in operative communication with computing device 400. The computing device 400 may comprise, but not be limited to, a desktop computer, laptop, a tablet, or mobile telecommunications device.

Embodiments of the present disclosure may comprise a system having a memory storage and a processing unit. The processing unit coupled to the memory storage, wherein the processing unit is configured to perform the stages of methods disclosed herein.

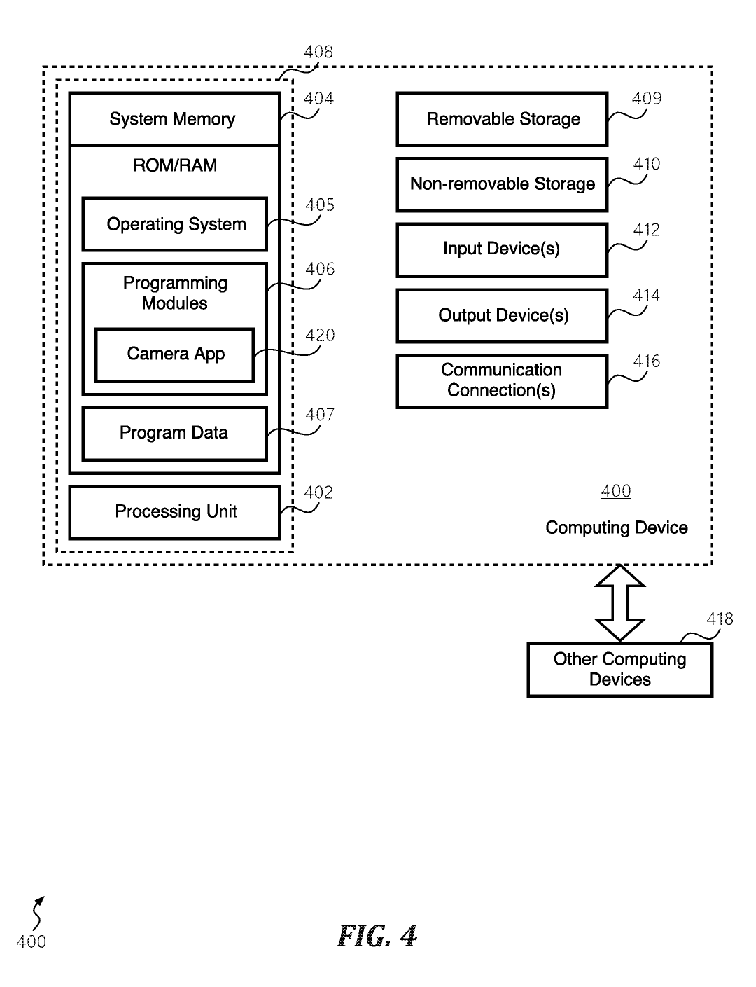

FIG. 4 is a block diagram of a system including computing device 400. Consistent with various embodiments of the present disclosure, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with various embodiments of the present disclosure.

With reference to FIG. 4, a system consistent with various embodiments of the present disclosure may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling the operation of computing device 400 operation. In one example, programming modules 406 may include mediating module 110, viewer 120 and subject interface modules 130, asset module 140, animation module 150, rules module 160, and payment module 170. In another example, aforesaid modules may, in whole or part, comprise discrete modules that are connected by way of a hardware bus, wired network connection, wireless network connection, or other communicative connection. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, a camera, a sensor, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network, direct-wired connection, or hardware bus, and wireless media such as acoustic, radio frequency (RF), infrared, and other wireless media. The term computer readable media as used herein may include both storage media and communication media.

As stated above, a number of program modules 406 and data files may be stored in system memory 404, including operating system 405. While executing on processing unit 402, programming modules 406 (e.g., scrolling enablement application 420) may perform processes including, for example, one or more of method stages as described above. The aforementioned process is an example, and processing unit 402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive or SD card), or a CD-ROM, a carrier wave from the Internet, or other forms of RAM or ROM. Further, the disclosed methods' stages may be modified in any manner, including by reordering stages and/or inserting or deleting stages, without departing from the disclosure.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving a request to view animation content, wherein the request comprises a selection of at least one of the following:
an animation asset, and
a message to be conveyed by the animation asset;
receiving data corresponding to an animation subject;
identifying animation assets based, at least in part, on the request;
generating animation instructions based on at least one of the following:
the message,
the received data, and
the animation assets; and
generating the animation content based on the animation instructions.

2. The method of claim 1, further comprising:
transmitting, to a viewer, the animation content, and
displaying, to the viewer, the animation content.

3. The method of claim 1, further comprising:
determining, based on at least one of the following: viewer data, rules module data, and payment module data, whether a viewer has permission to request the animation content, and
wherein generating the animation instructions comprises generating the animation instructions upon a determination of at least one of the following:
the viewer has permission to view the animation content, and
the message to be conveyed by the animation asset is a permissible message.

4. The method of claim 1, wherein generating the animation content comprises generating the animation content to convey the message received with the request.

5. A method comprising:
receiving a request from a viewer to interact with an animation subject, wherein the request comprises a selection of at least one animation asset to be depicted by the animation subject;
initiating an interactivity session, wherein the viewer and the animation subject are enabled to engage in bi-directional communication within the interactivity session;
receiving visual data and audio data depicting the animation subject,
wherein the animation subject is to be animated into animation content; and
generating the animation content using at least one of the following:
the at least one animation asset,
the visual data, and
the audio data.

6. The method of claim 5, further comprising:
determining, based on at least one of the following: viewer data, rules module data, and payment module data, whether a viewer has permission to request the animation content, and
wherein generating the animation instructions comprises generating animation instructions upon a determination of at least one of the following:
the viewer has permission to view the animation content, and
the message to be conveyed by the at least one animation asset is a permissible message.

7. The method of claim 5, further comprising:
transmitting the animation content, and
displaying the animation content to the viewer.

8. The method of claim 5, wherein receiving the request with the viewer further comprises payment data for interacting with the animation subject.

9. An animation system comprising:
a viewer interface module configured to enable a viewer to request animation content and to view the animation content, wherein the request for the animation content is configured to convey at least one of the following:
an animation asset, and
a message to be conveyed by the animation asset;
a subject interface module configured to enable an animation subject to direct at least one behavior of the animation asset, wherein the subject interface module is configured to receive sensor data associated with the animation subject, wherein the sensor data comprises data captured from at least one of the following:
video recording device, and
an audio recording device;
an asset module, wherein the asset module comprises animation assets to be depicted by the animation subject based on the captured data; and
an animation module, wherein the animation module comprises animation instructions configured to generate the animation content corresponding to the animation asset based on the captured data from the animation subject.

10. The animation system of claim 9, further comprising a rules module, wherein the rules module is configurable by at least one of a platform administrator, an asset administrator, a viewer, a parent or guardian of a viewer, a subscriber, an authorized payer, and an animation subject.

11. The animation system of claim 10, wherein the rules module is configured to regulate the scope of permissible animation of the animation assets.

12. The animation system of claim 10, wherein the rules module is configured to regulate the scope of permissible content provision to the viewer.

13. The animation system of claim 9, further comprising a payment module.

14. The computing system of claim 9, further comprising an artificial intelligence module, wherein the artificial intelligence module is configured to perform at least one of the following:
analyzing visual data, analyzing audio data, analyzing gestural data, predicting viewer behavior, predicting animation subject behavior, enforcing rules from a rules module, and enforcing payment requirements from a payment module.

15. The computing system of claim 9, wherein the viewer interface module is configured to receive the viewer input and display the animation content.

16. A computer-readable medium having a set of instructions which when executed by a computer are configured to perform a method, the method comprising:
receiving, from an animation subject, a command to generate animation content;
receiving visual data captured of the animation subject;
receiving animation assets based on a request to receiving the animation content from a viewer;
generating the animation content, using at least the visual data and the animation assets; and
transmitting, to the viewer, the animation content.

17. The computer-readable medium of claim 16, further comprising a rules module, wherein the rules module is configurable by at least one of a platform administrator, an asset administrator, a viewer, a parent or guardian of a viewer, a subscriber, an authorized payer, and an animation subject.

18. The computer-readable medium of claim 16, further comprising:
determining, based on at least one of the following: viewer data, rules module data, and payment module data, whether the viewer has permission to request the animation content, and
wherein generating animation instructions comprises generating animation instructions upon a determination of at least one of the following:
the viewer has permission to view the animation content, and
a message to be conveyed by the animation asset is a permissible message.

19. The computer-readable medium of claim 16, wherein generating the animation content comprises generating the animation content to convey a message received with the request.

20. The computer-readable medium of claim 16, wherein receiving the request with the viewer further comprises payment data for interacting with the animation subject.
